(19) United States
(12) Patent Application Publication
(10) Pub. No.: US 2023/0131768 A1
(43) Pub. Date: Apr. 27, 2023

(54) HOLDER DEVICE FOR PORTABLE TERMINALS CAPABLE OF WIRELESS CHARGING

(71) Applicant: Ga Young PARK, Seoul (KR)

(72) Inventor: Ga Young PARK, Seoul (KR)

(21) Appl. No.: 17/048,426

(22) PCT Filed: May 27, 2020
(86) PCT No.: PCT/KR2020/006816

§ 371 Date: Jan. 4, 2023

(30) Foreign Application Priority Data
May 21, 2020 (KR) 10-2020-0061101

(51) Int. Cl. H02J 7/00; H04M 1/04; H02J 50/10

(52) U.S. Cl. CPC H02J 7/0044; H04M 1/04; H02J 50/10

(57) ABSTRACT

Provided is a holder device for a portable terminal capable of wireless charging, the device comprising: a base part; a housing part; a holder part; a rotating part; a wireless power transmitter; and a processor configured to: determine an output of the wireless power based on one or more of mounting information indicating whether the housing part is mounted on the base part and rotation information indicating a rotation status of the holder part, and control the wireless power transmitter to transmit wireless power corresponding to the determined output to the portable terminal.

### TECHNICAL FIELD

The present disclosure relates to a holder device for a portable terminal capable of wireless charging, and more particularly, to a holder device for a portable terminal capable of wireless charging, the holder device which is capable of performing wireless charging at the same time as the portable terminal is mounted.

### BACKGROUND ART

In recent years, various kinds of accessories have been developed so that users can easily carry portable devices such as mobile phones and PMPs. As an example, an accessory in the form of a strap is provided at one side of a portable device to facilitate portability.

In general, the portable device is used by being held by a hand, and, in the case of watching a video for a long time or in some cases, the portable device may be used by being mounted on a floor surface such as a table. The strap-type accessory allows the portable device to be conveniently carried, but it is difficult to use when the portable device is mounted on the floor surface such as a table.

For this reason, there is a problem in that a separate accessory needs to be used to mount the portable device on the floor surface such as a table.

In order to solve this problem, an accessory for a portable electronic device including a base having a seating groove, a guider with an open entrance, a connection block comprised of a swing plate and a moving piece, a handle, and a cover has been proposed.

However, the existing accessory has a problem that when wireless charging is performed on a mobile phone, a holder comprised of a base and a ring blocks a wireless charging transmitter from a rear surface of the mobile phone where a receiver coil is embedded, and wireless charging is not performed properly.

Meanwhile, a different existing device includes a holding member for fixing and holding a mobile phone, a base for fixing and releasing using an absorption plate, and a connection shaft for connecting the base and the holding member, wherein the holding member includes a bottom supporting plate, a fixing side wall for fixing the mobile phone at one side of a front of the bottom supporting plate, first and second adjusting side walls positioned at the opposite to the fixing side wall and fixing and supporting the mobile phone by moving in the left, right, upward and downward directions, and a tension actuating unit that secures the mobile phone while elastically operating back and forth on the front of the floor support plate, wherein the base is connected to one side of the lower part of the connecting shaft with a rotating shaft, and wherein the other side of the lower part of the connection shaft is connected to the upper part of the absorption plate by a hinge shaft and the connection shaft is rotated forward from the vertical upper part to pressurize the absorption plate to fix or release the absorption plate; another existing device has spherical assembly grooves formed opposite to each other on both sides of the body, and an absorption fixing means which is inserted oppositely to adjust rotation in the spherical assembly grooves and fixedly installed at an installation position with an absorption plate or fixedly installs the mobile phone, wherein the absorption fixing means is formed by installing, on the top of the hemispherical base, a shaft bar with a spherical assembly hole inserted into the spherical assembly groove of the body part and by installing an elevating operation device having a cam inserted into a cam guideway inclined up and down on the circumference of the inner rib of the spherical assembly hole in the upper side and the absorption plate is fixed to the bottom inside the shaft bar; and yet another existing device is a holder having a base formed at both ends of the lower side to support a mobile phone and having a support formed at the upper side to support the mobile phone, the holder including the support installed on the upper side of the front of the holder and operated vertically by elasticity of a spring to support the upper side of the mobile phone, and a left-right support fastened to a lower end of the holder and operated left and right to move its position and supports the both side ends of the mobile phone.

These existing devices are provided with an adsorption plate as a fixing means and can be installed only on a glass window, and some of them can be installed only on one side of an audio device or a ventilator, so the installation location is limited.

### DISCLOSURE

### Technical Problem

The present disclosure is to provide a holder device for a portable terminal capable of wireless charging capable of performing wireless charging at the same time as the medicine is mounted on the portable terminal.

Other objects and advantages of the present disclosure will be understood from the following description and become more apparent by embodiments of the present disclosure. In addition, it is easily understood that the objects and advantages of the present disclosure may be implemented by means defined in the claims or their combinations.

### Technical Solution

In order to solve the above technical problem, the present disclosure provides a holder device for a portable terminal capable of wireless charging: the device including: a base part having a lower portion attached to a rear surface of the portable terminal; a housing part having a lower portion detachable from an upper portion of the base part; a holder part formed in a shape of a partly cut ring to be held by a user of the portable terminal; a rotating part having one side and the other side respectively coupled to the holder part and the housing part so that the holder part rotates with respect to the portable terminal; a wireless power transmitter configured to transmit wireless power to the portable terminal; and a processor configured to: determine an output of the wireless power based on one or more of mounting information indicating whether the housing part is mounted on the base part and rotation information indicating a rotation status of the holder part, and control the wireless power transmitter to transmit wireless power corresponding to the determined output to the portable terminal.

Preferably, the housing part may include: a rail groove formed by being recessed from one side of the lower portion of the housing part to a center of the lower side of the housing part to guide a detaching direction when attached to the base part; and a fixing protrusion formed to protrude from the inner other end of the rail groove in a direction perpendicular to the detaching direction.

Preferably, the base part may include: a rail protrusion formed to protrude from one side of an upper portion of the base part to a center of the upper portion of the base part to be inserted into the rail groove; and a fixing groove formed by being recessed in a direction perpendicular to the detaching direction to the other end of the rail protrusion so that the fixing protrusion is inserted.

The holder device for a portable terminal capable of wireless charging according to the present disclosure may further include a pressure sensing unit configured to measure an asperity contact pressure applied to the fixed protrusion.

Preferably, the processor may be further configured to determine the mounting information based on the asperity contact pressure.

Preferably, the rotating part may include: a first rotational shaft having one end coupled to one end of the holder part and the other end coupled to the other end, wherein a rotation axis of the first rotational shaft serves as a first rotation axis of a first rotation horizontal to an upper surface of the housing part while the holder part rotates; and a rotary body accommodating the first rotational shaft inside and supporting both ends of the first rotational shaft, wherein a rotation axis of the rotary body rotates in response to a second rotation perpendicular to the upper surface of the housing part while the holder part rotates.

Preferably, the rotating part comprises: a rotary plate formed in a disk shape and sealing a lower portion of the rotary body; and a second rotational shaft formed in a rod shape, having one end coupled to a center of a lower portion of the rotation plat and the other end coupled to the housing part, and serving as a second rotation axis of the second rotation.

The holder device for a portable terminal capable of wireless charging according to the present disclosure may further include: a first rotation sensing unit configured to measure a first rotation angle of the holder part in response to the first rotation; and a second rotation sensing unit configured to measure a second rotation angle of the holder part in response to the second rotation.

Preferably, the processor may be further configured to include the first rotation angle and the second rotation angle in the rotation information, determine to bock the output of the wireless power when the mounting information indicates a mounted state and the rotation information indicates a first rotation state, and determine to unblock the output of the wireless power when the mounting information indicates the mounted state and the rotation information indicates a second rotation state.

### Advantageous Effects

According to the present disclosure, the present disclosure can perform wireless charging at the same time as medicine is mounted on a portable terminal.

In addition, according to the present disclosure, it is possible to prevent overheating of the portable terminal by controlling wireless charging according to a mounted state of the portable terminal.

### DESCRIPTION OF DRAWINGS

FIG. 1 is a perspective view of a portable terminal holder device capable of wireless charging according to an embodiment of the present disclosure.

FIG. 2 is a block diagram illustrating a configuration of a portable terminal holder device capable of wireless charging according to an embodiment of the present disclosure.

FIG. 3 is a bottom perspective view of a base part and a holder part of a holder device for a portable terminal capable of wireless charging according to an embodiment of the present disclosure.

FIG. 4 is a view illustrating an upper portion of a holder device for a portable terminal capable of wireless charging according to an embodiment of the present disclosure.

FIG. 5 is an exploded perspective view of a holder device for a portable terminal capable of wireless charging according to an embodiment of the present disclosure.

FIG. 6 is a cross-sectional view taken along line A-A′ shown in FIG. 4.

FIG. 7 is a cross-sectional view taken along line B-B′ shown in FIG. 1.

FIG. 8 is a side view of a rotating part of a holder device for a portable terminal capable of wireless charging according to an embodiment of the present disclosure.

FIG. 9 is a cross-sectional view taken along line C-C′ shown in FIG. 8.

FIG. 10 is a cross-sectional view taken along line D-D′ shown in FIG. 5.

[Best Mode for Disclosure]

A holder device for a portable terminal capable of wireless charging according to the present disclosure may include: a base part having a lower portion attached to a rear surface of the portable terminal; a housing part having a lower portion detachable from an upper portion of the base part; a holder part formed in a shape of a partly cut ring to be held by a user of the portable terminal; a rotating part having one side and the other side respectively coupled to the holder part and the housing part so that the holder part rotates with respect to the portable terminal; a wireless power transmitter configured to transmit wireless power to the portable terminal; and a processor configured to: determine an output of the wireless power based on one or more of mounting information indicating whether the housing part is mounted on the base part and rotation information indicating a rotation status of the holder part, and control the wireless power transmitter to transmit wireless power corresponding to the determined output to the portable terminal.

[Mode for Disclosure]

Hereinafter, various embodiments of the present disclosure will be described in detail with reference to the accompanying drawings. However, the description is not intended to limit the present disclosure to particular embodiments, and it should be construed as including various modifications, equivalents, and/or alternatives according to the embodiments of the present disclosure. With regard to the description of the drawings, similar reference numerals may be used to refer to similar or related elements.

In the present disclosure, an expression such as “having,” “may have,” “comprising,” or “may comprise” indicates existence of a corresponding characteristic (e.g., a numerical value, a function, an operation, or an element like a part) and does not exclude existence of additional characteristic.

In the present disclosure, an expression such as “A or B,” “at least one of A or/and B,” or “one or more of A or/and B” may include all possible combinations of together listed items. For example, “A or B,” “at least one of A and B,” or “one or more of A or B” may indicate the entire of (1) including at least one A, (2) including at least one B, or (3) including both at least one A and at least one B.

Expressions such as “first,” “second,” “primarily,” or “secondary,” used in various embodiments may represent various elements regardless of order and/or importance and do not limit corresponding elements. The expressions may be used for distinguishing one element from another element. For example, a first user device and a second user device may represent different user devices regardless of order or importance. For example, a first element may be named as a second element without departing from the right scope of the various exemplary embodiments of the present disclosure, and similarly, a second element may be named as a first element.

When it is described that an element (such as a first element) is “operatively or communicatively coupled with/to” or “connected” to another element (such as a second element), the element can be directly connected to the other element or can be connected to the other element through another element (e.g., a third element). However, when it is described that an element (e.g., a first element) is “directly connected” or “directly coupled” to another element (e.g., a second element), it means that there is no intermediate element (e.g., a third element) between the element and the other element.

An expression “configured to (or set)” used in the present disclosure may be replaced with, for example, “suitable for,” “having the capacity to,” “designed to,” “adapted to,” “made to,” or “capable of” according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a dedicated processor (e.g., an embedded processor) for performing a corresponding operation or a generic-purpose processor (such as a CPU or an application processor) that can perform a corresponding operation by executing at least one software program stored at a memory device.

Terms defined in the present disclosure are used for only describing a specific exemplary embodiment and may not have an intention to limit the scope of other exemplary embodiments. It is to be understood that a singular form of a noun corresponding to an item may include one or more of the things, unless the relevant context clearly indicates otherwise. All of the terms used herein including technical or scientific terms have the same meanings as those generally understood by an ordinary skilled person in the related art. The terms defined in a generally used dictionary should be interpreted as having meanings that are the same as or similar with the contextual meanings of the relevant technology and should not be interpreted as having ideal or exaggerated meanings unless they are clearly defined in the various exemplary embodiments. In some case, terms defined in the present disclosure cannot be analyzed to exclude the present exemplary embodiments.

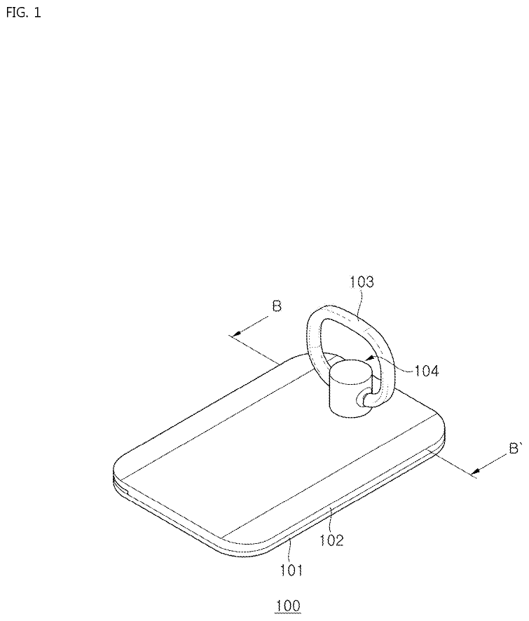

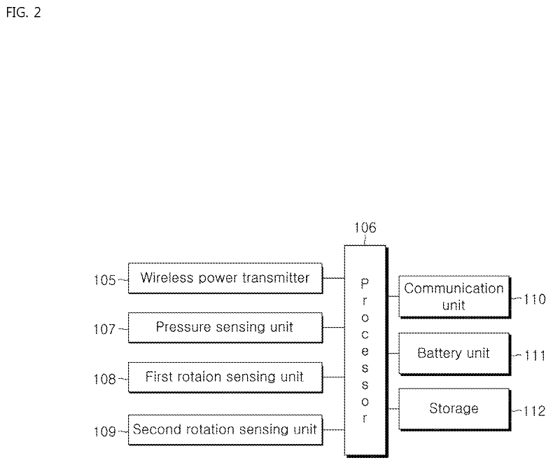

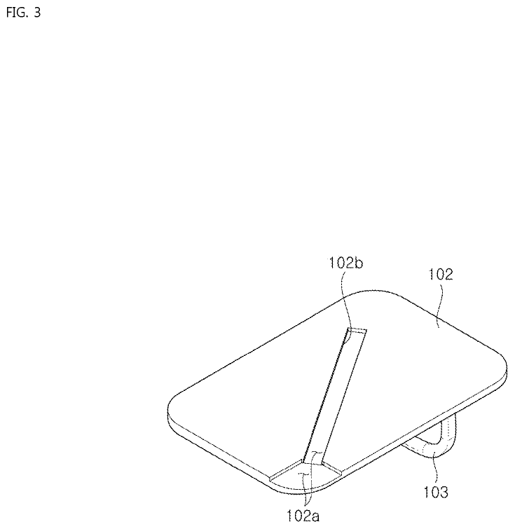

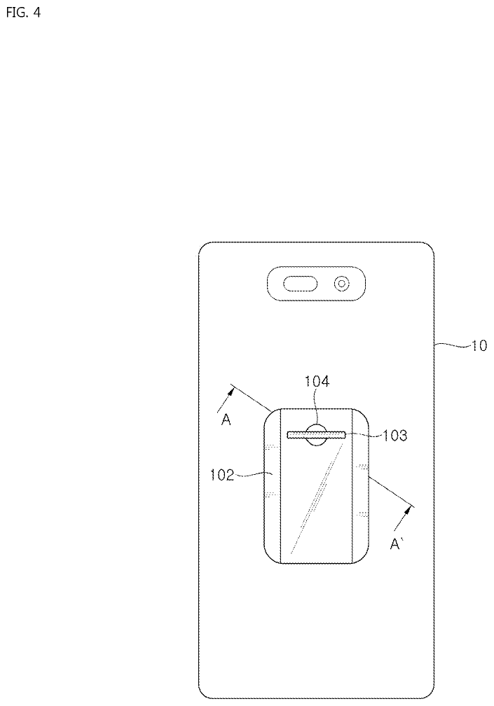

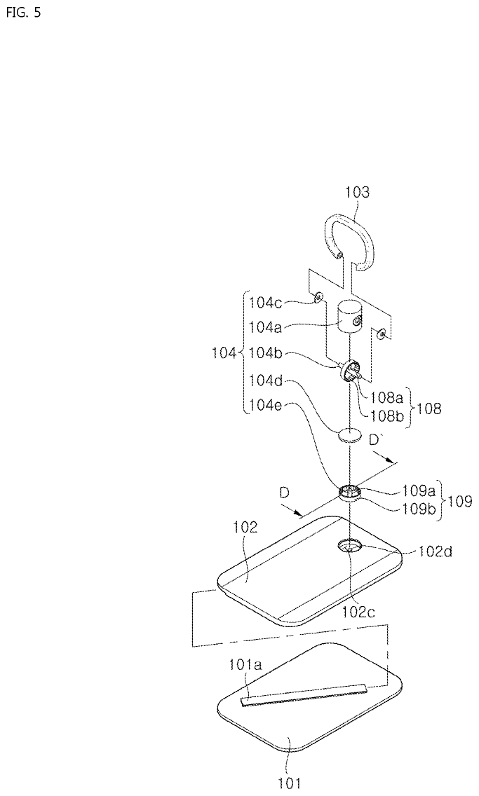

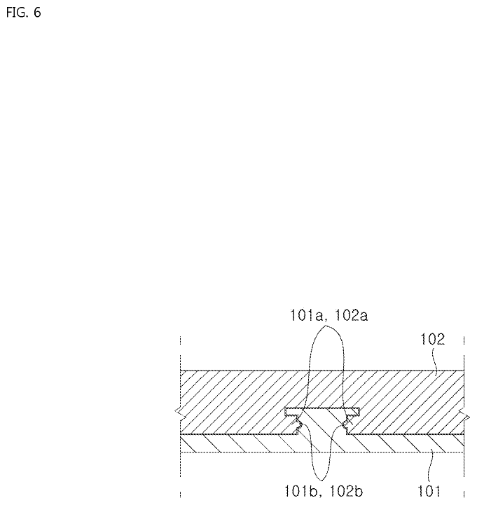

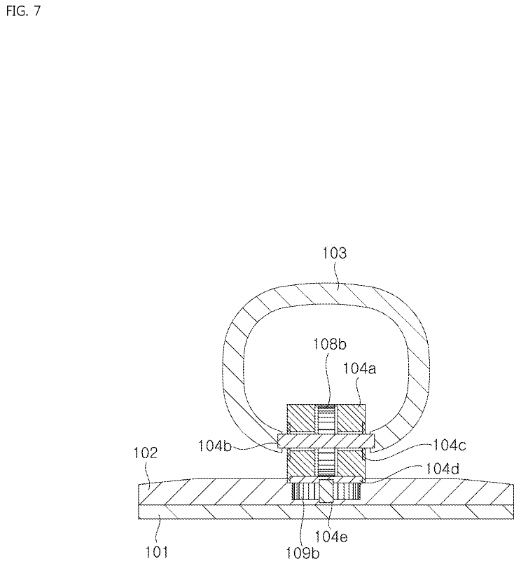

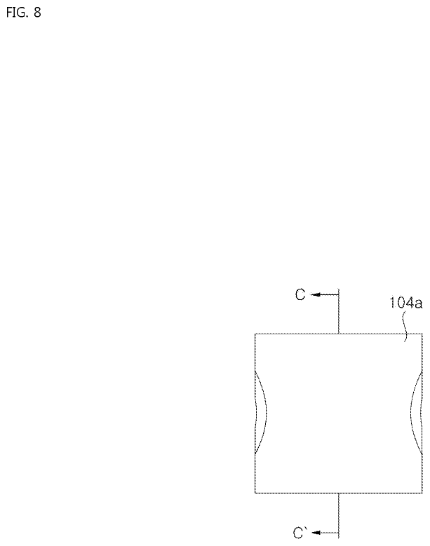

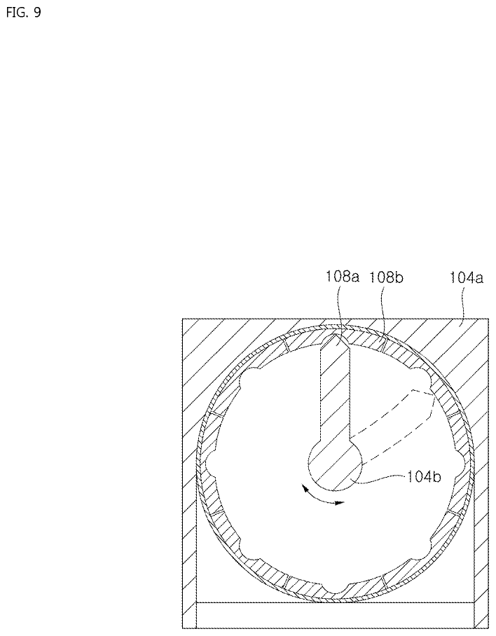

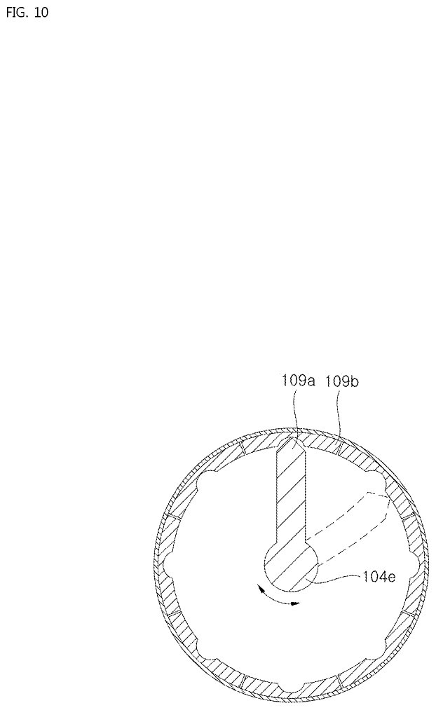

FIG. 1 is a perspective view of a portable terminal holder device 100 capable of wireless charging according to an embodiment of the present disclosure, FIG. 2 is a block diagram illustrating a configuration of a portable terminal holder device 100 capable of wireless charging according to an embodiment of the present disclosure, FIG. 3 is a bottom perspective view of a base part 101 and a holder part 103 of a holder device 100 for a portable terminal capable of wireless charging according to an embodiment of the present disclosure, FIG. 4 is a view illustrating an upper portion of a holder device 100 for a portable terminal capable of wireless charging according to an embodiment of the present disclosure, FIG. 5 is an exploded perspective view of a holder device 100 for a portable terminal capable of wireless charging according to an embodiment of the present disclosure, FIG. 6 is a cross-sectional view taken along line A-A′ shown in FIG. 4, FIG. 7 is a cross-sectional view taken along line B-B′ shown in FIG. 1, FIG. 8 is a side view of a rotating part 104 of a holder device 100 for a portable terminal capable of wireless charging according to an embodiment of the present disclosure, FIG. 9 is a cross-sectional view taken along line C-C′ shown in FIG. 8, and FIG. 10 is a cross-sectional view taken along line D-D′ shown in FIG. 5.

Referring to FIGS. 1 to 10, a holder device 100 for a portable terminal capable of wireless charging according to an embodiment of the present disclosure may include a portable terminal 10, a base part 101, a housing part 102, and a holder part 103, a rotating part 104, a wireless power transmitter 105, a processor 106, a pressure sensing unit 107, a first rotation sensing unit 108, a second rotation sensing unit 109, a communication unit 110, a battery unit 111 and a storage 112.

The base part 101 may have a lower portion attached to a rear surface of the portable terminal 10. To this end, the base part 101 may include an adhesive member at the lower portion. Here, the type of the adhesive member may be an adhesive tape and an adhesive and may not be limited as long as attaching the base part 101 to the portable terminal.

The base part 101 may include a rail protrusion 101a and a fixing groove 101b so that the housing part 102 is coupled thereto.

Specifically, the rail protrusion 101a may be formed to protrude from one side of the upper portion of the base part 101 to the center of the upper portion of the base part 101, so that the rail protrusion 101a is inserted into the rail groove 102a provided in a lower portion of the housing part 102.

A cross section of the rail protrusion 101a may be formed in a “T” shape.

Meanwhile, the fixing groove 101b may be formed by being recessed at the other end of the rail protrusion 101a in a direction perpendicular to a detaching direction in which the base part 101 and the housing part 102 are detached, so that the fixing protrusion 102b formed in the rail groove 102a is inserted into the fixing groove.

The lower portion of the housing part 102 may be detachable from the upper portion of the base part 101. In addition, the wireless power transmitter 105, the processor 106, the pressure sensing unit 107, the communication unit 110, the battery unit 111, and the storage 112 may be accommodated in the housing part 102.

In order to be detached from the base part 101, the housing part 102 may be provided with a rail groove 102a and a fixing protrusion 102b.

Specifically, in order to guide a detaching direction when detached from the base part, the rail groove 102a may be formed by being recessed from the lower portion of the housing part 102 to the lower center of the housing part 102 so that the detachable direction is guided. The rail protrusion 101a may be inserted and guided in the rail groove 102a.

The fixing protrusion 102b may be formed to protrude from the inner other end of the rail groove 102a in a direction perpendicular to the detaching direction. At this time, at the end of insertion during the process of inserting the rail protrusion 101a into the rail groove 102a, the fixing protrusion 102b may be pressed by the rail protrusion 101a and then inserted into the fixing groove 101b to release the pressure.

In this way, the housing part 102 may be mounted on the base part 101.

Meanwhile, the housing part 102 may be formed by being recessed from an upper surface to the lower portion, and may further have a receiving groove 102c in which a second rotational shaft 104e of the rotating part 104 and a second rotation sensing unit 109 are accommodated.

The receiving groove 102c may have a circular cross section, a step may be formed at a height to contact the upper surface, and a rotary plate 104d of the rotating part 104 may be seated on the formed step.

In this case, a rotation groove 102d that is rotatably coupled to the other end of the second rotational shaft 104d may be formed at an inner center of the receiving groove 102c.

That is, the second rotational shaft 104e may be received in a state erected in the receiving groove 102c, one end of the second rotational shaft may be coupled to a lower center of the rotary plate 104d, the other end of the second rotational shaft may be rotatably coupled to the rotation groove 102d, and accordingly, the second rotational shaft may rotate in response to rotation of the rotary plate 104d.

The holder part 103 may is formed in the shape of a partly cut ring to be held by a user of the portable terminal 10. Specifically, when a portion of the user's body (finger) is inserted into the holder part 103 and held by the user, a first rotation R1 or a second rotation R2 may be performed by a force applied from the user.

Here, the first rotation R1 may be a rotation of which a rotation axis is horizontal to the upper surface of the housing part 102, and the second rotation R1 may be a rotation of which a rotation axis is perpendicular to the upper surface of the housing part 102. In this case, the rotation axis of the first rotation R1 may be a first rotation axis, and the rotation axis of the second rotation R2 may be a second rotation axis. Furthermore, the first rotational shaft may be the same as the first rotational shaft 104b, and the second rotational shaft may be the same as the second rotational shaft 104e.

Meanwhile, in the holder part 103, cut-away one end may be coupled to one end of the first rotational shaft 104b of the rotating part 104, and the cut-away other end may be coupled to the other end of the first rotational shaft 104b of the rotating part 104.

One side and the other side of the rotating part 104 may be coupled to the holder part 103 and the housing part 102, respectively, so that the holder part 103 rotates with respect to the portable terminal 10.

To this end, the rotating part 104 may include a rotary body 104a, a first rotational shaft 104b, a pair of rotary covers 104c, a rotary plate 104d, and a second rotational shaft 104e.

The rotary body 104a may be formed in a cylindrical shape, and may accommodate the first rotational shaft 104b, may support the rotary cover 104b into which both ends of the first rotational shaft 104b are inserted, and may rotate in response to the second rotation R2 of which a rotation axis is perpendicular to the upper surface of the housing part 102 while the holder part 103 rotates.

Meanwhile, the first rotational shaft 104b may be formed in a rod shape, one end of the first rotational shaft 104b may be coupled to one end of the holder part 103, the other end of the first rotational shaft 104b may be coupled to the other end of the holder part 103, and a rotation axis of the first rotational shaft 104b may become the first rotation axis of the first rotation R2 horizontal to the upper surface of the housing part 102 while the holder part 103 rotates.

Each of the rotary covers 104c may be formed in a disk shape with a center penetrated therethrough, and both ends of the first rotational shaft 104b may be inserted into the penetrated portion to support the first rotational shaft 104b.

The rotary plate 104d may be formed in a disk shape and may seal the lower portion of the rotary body 104a. In this case, a portion of the lower portion of the rotary body 104a and a portion of the lower portion of the rotary plate 104d may be mounted on the step formed in the receiving groove 102c.

The second rotational shaft 104e may be formed in a rod shape, one end of second rotational shaft may be coupled to the lower center of the rotary plate 104e, the other end of second rotational shaft may be rotatably coupled to the rotation groove 102d of the housing part 102 and may be the second rotation axis of the second rotation R2.

The wireless power transmitter 105 may wirelessly transmit power charged in the battery unit 111 to the portable terminal 10 under the control of the processor 106.

To this end, the wireless power transmitter 105 may include a wireless power transmission coil and a power conversion circuit.

Meanwhile, a wireless power transmission method of the wireless power transmitter 105 may not be limited as long as wirelessly transmitting power charged in the battery unit 111 to the portable terminal 10.

The processor 106 may control operation of the wireless power transmitter 105, the pressure sensing unit 107, the first rotation sensing unit 108, the second rotation sensing unit 109, the communication unit 110, the battery unit 111, and the storage.

The processor 106 may include one or more cores (not shown), a graphic processing unit (not shown), and/or a connection path (e.g., a bus) for transmitting and receiving signals to and from other components.

The processor 106 according to an embodiment may be configured to perform an operation of the holder device 100 for the portable terminal capable of wireless charging, by executing one or more instructions stored in the storage 1112.

Specifically, the processor 106 may determine an output of wireless power based on one or more of mounting information indicating whether the housing part 102 is mounted on the base part 101 and rotation information indicating a rotation state of the holder part 103, and may control the wireless power transmitter 105 so that wireless power corresponding to the determined output can be transmitted to the portable terminal 10.

The processor 106 may determine the mounting information based on asperity contact pressure applied to the fixed protrusion. Here, the asperity contact pressure may be measured by the pressure sensing unit 107. At the end of the process of inserting the rail protrusion 101a into the rail groove 102a, the fixing protrusion 102b may be pressed by the rail protrusion 101a and then inserted into the fixing groove 101b to release the pressure.

In this case, the pressure sensing unit 107 may measure asperity contact pressure at the moment when the fixing protrusion 102b is pressed by the rail protrusion 101a.

Conversely, during the process of separating the rail protrusion 101a from the rail groove 102a, in the initial stage of the separation, the fixing protrusion 102b may be pressed by the rail protrusion 101a and then the pressure may be released.

In this case, the pressure sensing unit 107 may measure asperity contact pressure at the moment when the fixing protrusion 102b is pressed by the rail protrusion 101a.

Using this, when asperity contact pressure above a preset reference pressure has been measured for more than a preset reference time and then the protrusion pressure is not measured, the processor 106 may check previously determined mounting information and determine mounting information to be opposite to the previously determined mounting information.

For example, if the previously determined mounting information indicates a non-mounted state, the processor 106 may determine mounting information to indicate that the housing part 102 is mounted on the base part 101.

Conversely, if the previously determined mounting information indicates a mounted state, the processor 106 may determine mounting information to indicate that the housing part 102 is not mounted on the base part 101.

Meanwhile, the processor 106 may include, in the rotation information, a first rotation angle of the holder part 103 according to the first rotation R1 and a second rotation angle of the holder part 103 according to the second rotation R2.

Here, the first rotation sensing unit 108 may measure the first rotation angle of the holder part 103 in response to the first rotation R1, and the second rotation sensing unit 208 may measures the second rotation angle of the holder part 203 in response to the second rotation R2.

The processor 106 may determines to block output of wireless power when the mounting information indicates a mounted state and the rotation information indicates a first rotation state, and may determine to unblock the output of wireless power when the mounting information indicates a mounted state and the rotation information indicates a second rotation state.

Here, the first rotation state may be a case where the first rotation angle and the second rotation angle are included in a preset first reference angle range and a preset second reference angle range, respectively, and the second rotation state may be a case where the first rotation angle and the second rotation angle are included in a preset third reference angle range and a preset fourth reference angle range, respectively.

For example, the preset first reference angle range may be 30 degrees or more and 150 degrees or less, the preset second reference angle range may be 80 degrees or more and 100 degrees or less, 170 degrees or more and 190 degrees or less, 260 degrees or more and 280 degrees or less, and 350 degrees or more and 10 degrees or less.

Conversely, the preset third reference angle range may be 0 degrees or more and less than 30 degrees and 150 degrees or more and 180 degrees or less, and the preset fourth reference angle range may be the entire range of 360 degrees.

That is, the processor 106 may control the wireless power transmitter 105 to block wireless charging when the holder part 103 is in the first rotation state, and to perform wireless charging when the holder part is in the second rotation state.

In doing so, in a rotating state of the holder part 103, which is estimated as a user environment with high power consumption, such as watching a video, wireless charging that causes heat generation of the mobile terminal 10 may be blocked to prevent overheating of the mobile terminal 10.

The first rotation sensing unit 108 may measure the first rotation angle of the holder part 103 in response to the first rotation R1.

To this end, the first rotation sensing unit 108 may include a first rotary pole 108a and a plurality of first rotation sensors 109b.

The first rotary pole 108a may be formed in a rod shape, and may be formed to protrude from the first rotational shaft 104b in a direction perpendicular to a longitudinal direction of the first rotational shaft 104b. The first rotary pole 108a may rotate together with the first rotation R1 of the first rotational shaft 104b. The first rotary pole 108a may be formed of a material having flexibility and conductivity.

The plurality of first rotation sensors 108b may be spaced apart from each other at a predetermined interval to form a circle so as to be in contact with the ends of the first rotary pole 108b, and a sensor groove into which an end of the first rotary pole 108b is inserted and temporarily fixed may be formed at a center of each of the plurality of first rotation sensors 108b.

Each of the plurality of first rotation sensors 108b may be formed to have a different resistance value. Accordingly, the processor 106 may receive an electrical signal (a current signal or a voltage signal) corresponding to the resistance value of a first rotation sensor 108b in contact with the first rotary pole 108b, from any one of the first rotation sensors 108b, and may be converted into the first rotation angle based on the electrical signal corresponding to the resistance value.

The second rotation sensing unit 109 may measure the second rotation angle of the holder part 103 in response to the second rotation R2.

To this end, the second rotation sensing unit 109 may include a second rotary pole 109a and a plurality of second rotation sensors 109b.

The second rotary pole 109a may be formed in a rod shape, and may be formed to protrude from the second rotational shaft 104b in a direction perpendicular to a longitudinal direction of the second rotational shaft 104b. The second rotary pole 109a may rotate together with the second rotation R1 of the second rotational shaft 104b. The second rotary pole 109a may be formed of a material having flexibility and conductivity.

The plurality of second rotation sensors 109b may be spaced apart from each other at a predetermined interval to form a circle so as to be in contact with the ends of the second rotary poles 109b, and a sensor groove into which an end of the second rotary pole 109b is inserted and temporarily fixed may be formed at a center of each of the plurality of second rotation sensors 109b.

Each of the plurality of second rotation sensors 109b may be formed to have a different resistance value. Accordingly, the processor 106 may receive an electrical signal (a current signal or a voltage signal) corresponding to the resistance value of a second rotation sensor 109b in contact with the second rotary pole 109b, from any one of the second rotation sensors 109b, and may be converted into the second rotation angle based on the electrical signal corresponding to the resistance value.

The communication unit 110 may communicate with the portable terminal 10 using one or more of short-range wireless communication technologies to transmit and receive information used for wireless charging.

For example, the communication unit 110 may receive one or more of a charge request signal, a charge interruption signal, and information on a remaining charge amount of a battery of the portable terminal from the portable terminal 10.

The communication unit 110 may include a short-range wireless communication module that performs short-range wireless communication. Here, it should be noted that short-range wireless communication is not limited to a communication method as long as communication is performed in a short range. For example, short-range wireless communication may use one or more of Bluetooth, Near Field Communication (NFC), and infrared communication.

The battery unit 111 may be charged with power transmitted to the portable terminal 10 and may supply power required for the operation of the holder device 100 for the portable terminal capable of wireless charging. In this case, the type of battery of the battery unit 111 may not be limited.

The storage 112 may store programs (one or more instructions) for processing and controlling the processor 106. The programs stored in the storage 112 may be divided into a plurality of modules by function.

The present disclosure has been shown and described with reference to certain exemplary embodiments thereof. However, it will be understood by those skilled in the art that various changes in form and details may be made therein without departing from the spirit and scope of the invention as defined by the appended claims. Therefore, it should be understood that embodiments described herein should be considered in a descriptive sense only and not for purposes of limitation. The scope of the present disclosure is defined not by the detailed description but by the appended claims, and all differences within the scope will be construed as being included in the present disclosure.

Although the present disclosure has been described with limited embodiments and drawings, the present disclosure is not limited to thereto, and instead, it would be appreciated by those skilled in the art that changes may be made to these embodiments without departing from the principles and spirit of the present disclosure, the scope of which is defined by the claims and their equivalents.

1. A holder device for a portable terminal capable of wireless charging: the device comprising:
a base part having a lower portion attached to a rear surface of the portable terminal;
a housing part having a lower portion detachable from an upper portion of the base part;
a holder part formed in a shape of a partly cut ring to be held by a user of the portable terminal;
a rotating part having one side and the other side respectively coupled to the holder part and the housing part so that the holder part rotates with respect to the portable terminal;
a wireless power transmitter configured to transmit wireless power to the portable terminal; and
a processor configured to determine an output of the wireless power based on one or more of mounting information indicating whether the housing part is mounted on the base part and rotation information indicating a rotation status of the holder part, and control the wireless power transmitter to transmit wireless power corresponding to the determined output to the portable terminal.

2. The holder device of claim 1, wherein the housing part comprises:
a rail groove formed by being recessed from one side of the lower portion of the housing part to a center of the lower side of the housing part to guide a detaching direction when detached from the base part; and
a fixing protrusion formed to protrude from the inner other end of the rail groove in a direction perpendicular to the detaching direction.

3. The holder device of claim 2, wherein the base part comprises:
a rail protrusion formed to protrude from one side of an upper portion of the base part to a center of the upper portion of the base part to be inserted into the rail groove; and
a fixing groove formed by being recessed in a direction perpendicular to the detaching direction to the other end of the rail protrusion so that the fixing protrusion is inserted.

4. The holder device of claim 3, further comprising a pressure sensing unit configured to measure an asperity contact pressure applied to the fixed protrusion,
wherein the processor is further configured to determine the mounting information based on the asperity contact pressure.

5. The holder device of claim 1, wherein the rotating part comprises:
a first rotational shaft having one end coupled to one end of the holder part and the other end coupled to the other end, wherein a rotation axis of the first rotational shaft serves as a first rotation axis of a first rotation horizontal to an upper surface of the housing part while the holder part rotates; and
a rotary body accommodating the first rotational shaft inside and supporting both ends of the first rotational shaft, wherein a rotation axis of the rotary body rotates in response to a second rotation perpendicular to the upper surface of the housing part while the holder part rotates.

6. The holder device of claim 5, wherein the rotating part comprises:
a rotary plate formed in a disk shape and sealing a lower portion of the rotary body; and
a second rotational shaft formed in a rod shape, having one end coupled to a center of a lower portion of the rotation plat and the other end coupled to the housing part, and serving as a second rotation axis of the second rotation.

7. The holder device of claim 6, further comprising:
a first rotation sensing unit configured to measure a first rotation angle of the holder part in response to the first rotation; and
a second rotation sensing unit configured to measure a second rotation angle of the holder part in response to the second rotation,
wherein the processor is further configured to include the first rotation angle and the second rotation angle in the rotation information, determine to bock the output of the wireless power when the mounting information indicates a mounted state and the rotation information indicates a first rotation state, and determine to unblock the output of the wireless power when the mounting information indicates the mounted state and the rotation information indicates a second rotation state.
